(19) United States
(12) Patent Application Publication
(10) Pub. No.: US 2006/0291745 A1
(43) Pub. Date: Dec. 28, 2006

(54) Apparatus and method for compensating for defective pixel

(75) Inventors: Ki-min Kang, Seongnam-si (KR); Goo-soo Gahang, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/385,872

(22) Filed: Mar. 22, 2006

(30) Foreign Application Priority Data
Jun. 28, 2005 (KR) 10-2005-0056230

(51) Int. Cl. G06K 9/40; H04N 1/405

(52) U.S. Cl. 382/275; 358/3.06

(57) ABSTRACT

An apparatus and a method for compensating for a defective pixel are provided. The apparatus includes a defective pixel information detecting unit and a halftoning unit. The defective pixel information detecting unit detects whether input continuous gray scale data forms a defective pixel caused by a defective image-forming element and outputs the detected result as defective pixel information. The halftoning unit reflects the defective pixel information in halftoning of the continuous gray scale data using error diffusion. In an image-forming apparatus (such as a printer, an LED etc) reproducing continuous gray scales using a plurality of image-forming elements each forming a limited gray scale, image quality deterioration caused by the defective pixel can be compensated for by performing halftoning in consideration of the defective image-forming element when some of the image-forming elements are defective.

### CROSS-REFERENCE TO RELATED PATENT APPLICATION

This application claims the benefit under 35 U.S.C. §119(a) of Korean Patent Application No. 10-2005-0056230, filed on Jun. 28, 2005, in the Korean Intellectual Property Office, the entire contents of which are hereby incorporated herein by reference.

### BACKGROUND OF THE INVENTION

1. Field of the Invention

The present invention relates to an apparatus and method for compensating for a defective pixel. More particularly, the present invention relates to an apparatus and a method for compensating for a defective pixel that are capable of compensating for image quality deterioration caused by the defective pixel by performing halftoning in consideration of a defective image-forming element when some of a plurality of image-forming elements are defective in an image-forming apparatus (e.g., a printer or a light-emitting diode (LED)) reproducing a continuous gray scale using the image-forming elements forming limited gray scale pixels.

2. Description of the Related Art

An image-forming apparatus such as a printer or an LED comprises a plurality of image-forming elements for forming limited gray scale pixels. The image-forming elements may be an array of ink injection nozles, respective positions on a surface of a photosensitive drum, or an array of LEDs. The image-forming apparatus reproduces a continuous gray scale image using the plurality of image-forming elements.

A conventional inkjet printer that reproduces a 256 gray scale image will now be described. The inkjet printer reproduces a continuous gray scale image such as a 256 gray scale image by appropriately grouping and arranging pixels on which ink is emitted or not emitted. Halftoning is a screening technique that can employ a two-dimensional matrix or an error diffusion technique. That is, continuous gray scale data is converted into an amount of limited gray scale data through the halftoning process, and the converted data is input to an image-forming element disposed at a respective position to form a limited gray scale pixel.

However, in the case of a defective image-forming element such as an ink emission nozzle that cannot emit ink, a defective pixel is generated and, as a result, collected pixel groups containing the defective pixel cannot reproduce an exact continuous gray scale.

To compensate for the above defective pixel, a method by which a normal image-forming element forms a gray scale value that the defective image-forming element should provide, at a pixel adjacent to the defective pixel, has been used in the related art.

FIG. 1 is a block diagram of a conventional apparatus for compensating for a defective pixel.

First, continuous gray scale data (e.g., 256-level gray scale data) is input to a halftoning unit 100. The halftoning unit 100 converts the continuous gray scale data into data that corresponds to a low-level gray scale value that can be reproduced by an image-forming element (i.e., halftoning-processed data) and outputs the same. The value of the halftoning-processed data in an inkjet printer has a value of 0 or 1. For example, an ink emission nozzle that has received halftoning-processed data of 0 does not emit the ink, and an ink emission nozzle that has received halftoning-processed data of 1 emits the ink.

A defective image-forming element determining unit 110 detects or stores in advance the position of a defective image-forming element (e.g., an ink emission nozzle that does not emit the ink) to provide information regarding the position of the defective image-forming element to a data rearranging unit 120.

The data rearranging unit 120 detects a defective pixel based on the information regarding the defective image-forming element and rearranges halftoning-processed data provided from the halftoning unit 100. The rearranging is performed by rearranging data so that the ink may be emitted to a pixel adjacent to the defective pixel.

An image-forming unit 130 comprising a plurality of image-forming elements receives the rearranged halftoning-processed data to form an image having the above input 256-level gray scale data.

FIGS. 2A through 2D are conceptual views of a data rearranging technique, which is a conventional method of compensating for a defective pixel.

FIG. 2A illustrates an arrangement of pixels formed using a printer having defective ink emission nozzles without using a method of compensating for a defective pixel. White circles represent pixels that correspond to normal ink emission nozzles, and gray circles represent pixels that correspond to defective ink emission nozzles and therefore defective pixels. The defective pixels may be blank dots where the ink is not emitted, for example.

FIG. 2B illustrates an image formed by rearranging and printing halftoning-processed data so as to compensate for the defective pixels under the condition of FIG. 2A. In FIG. 2A, the ink is not emitted on the positions of the defective pixels but emitted on positions adjacent to the positions of the defective pixels. That is, the pixels on which the ink is to be emitted are rearranged in directions indicated by arrows shown in FIG. 2B.

FIG. 2C is a view for illustrating a conventional method of compensating for adjacent defective blank pixels by increasing an ink emission amount of the adjacent pixels in the compensation method of FIG. 2B. FIG. 2D is a view for illustrating a compensation method of synthesizing a black color by overlapping colors of cyan, magenta, and yellow and printing the same using color-ink emission nozzles with respect to a defective pixel generated because black ink is not emitted in a black/white printing mode of a color printer.

However, in the related art, when defective pixels are densely populated, a complicated algorithm is required to determine adjacent pixels that can be substituted for the respective defective pixels, and other devices and signal lines are required to perform the complicated algorithm. Also, a user may identify the position of a compensated defective pixel caused by a regular compensation pattern on which compensation is performed using pixels immediately adjacent to the defective pixel. In that case, the compensation method may not be an effective method of compensating for a defective pixel. Also, since the method of emitting an excessive amount of ink on the adjacent pixel requires controlling the amount of ink, elaborate and complicated control logic and circuitry are required. Also, the method of synthesizing a black pixel can be used only in the black/white printing mode of the color printer, and an excessive amount of ink is consumed unnecessarily.

### SUMMARY OF THE INVENTION

The present invention provides an apparatus and a method for compensating for a defective pixel capable of compensating for image quality deterioration caused by the defective pixel by performing halftoning in consideration of a defective image-forming element when some of a plurality of image-forming elements are defective in an image-forming apparatus (such as a printer, a light-emitting diode (LED), and so on) reproducing a continuous gray scale using the image-forming elements forming a limited gray scale pixels.

According to an aspect of the present invention, there is provided an apparatus for compensating for a defective pixel comprising a defective pixel information detecting unit for detecting whether input continuous gray scale data forms a defective pixel caused by a defective image-forming element and outputting the detected result for defective pixel information, and a halftoning unit for halftoning the continuous gray scale data using error diffusion depending on or in consideration of the defective pixel information.

The halftoning unit may comprise a quantizing unit for quantizing and outputting input data, a data selecting unit for selecting preset data or the quantized data based on the defective pixel information and outputting the selected data as halftone-processed data, a subtracter for subtracting an output of the data selecting unit from the input data and outputting the subtracted result as an error, an error diffusion unit for diffusing the error to neighboring pixels, and an adder for adding the continuous gray scale data and the diffused error and outputting the result as input data.

According to another aspect of the present invention, there is provided a method of compensating for a defective pixel comprising detecting whether input continuous gray scale data forms a defective pixel caused by a defective image-forming element and determining the detected result as defective pixel information, and halftoning the continuous gray scale data using error diffusion depending on or in consideration of the defective pixel information.

The halftoning may comprise adding the continuous gray scale data and a diffused error to generate input data, quantizing the input data, determining whether the continuous gray scale data forms a defective pixel based on the defective pixel information, if the defective pixel is judged to be formed, determining preset data as halftone-processed data, and determining the quantized data as the halftone-processed data if the defective pixel is not judged to be formed, wherein an error is calculated by subtracting the halftone-processed data from the input data, and the diffused error is generated by diffusing the calculated error to neighboring pixels.

According to another aspect of the present invention, there is provided a computer-readable recording medium having recorded thereon a program for compensating for a defective pixel, wherein the program controls an apparatus for compensating for the defective pixel by detecting whether input continuous gray scale data forms a defective pixel caused by a defective image-forming element and determining the detected result as defective pixel information, and halftoning the continuous gray scale data using error diffusion depending on or in consideration of the defective pixel information.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of conventional apparatus for compensating for a defective pixel;

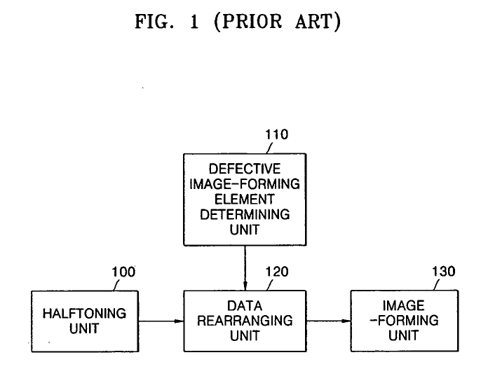

FIGS. 2A through 2D are conceptual views of a data rearranging technique, which is a conventional method of compensating for a defective pixel;

FIG. 3 is a block diagram of an apparatus for compensating for a defective pixel according to an exemplary embodiment of the present invention;

FIGS. 4A and 4B are conceptual views illustrating a case where a defective ink emission nozzle exists in an ink emission nozzle set;

FIGS. 5A and 5B are conceptual views illustrating a case where defective portions exist on a photosensitive drum surface of a laser printer;

FIGS. 6A and 6B are conceptual views illustrating examples where a defective pixel is detected in an ink emission nozzle set;

FIGS. 7A and 7B are block diagrams illustrating operations of a defective pixel information detecting unit and a data selecting unit according to an exemplary embodiment of the present invention;

FIG. 8 is a view of a Floyd-Steinberg error filter, according to an exemplary embodiment of the present invention;

FIG. 9 is a flowchart for explaining operations of an apparatus and a method for compensating for a defective pixel according to an exemplary embodiment of the present invention; and

FIG. 10 is a view illustrating a printed result obtained using an exemplary embodiment of the present invention and compared with the conventional data rearranging technique of FIG. 2A.

Throughout the drawings, like reference numerals will be understood to refer to like parts, components and structures.

### DETAILED DESCRIPTION OF THE EXEMPLARY EMBODIMENTS

The present invention will now be described more fully with reference to the accompanying drawings, in which exemplary embodiments of the invention are shown. In the following description, a detailed description of known functions and configurations incorporated herein has been omitted for clarity and conciseness.

An image-forming apparatus to which the present invention is applied is assumed to be a printer for illustrative purposes. However, the application of the present invention is not limited to a printer but can be readily applied to any image-forming apparatus reproducing a continuous gray scale image using limited level gray scale pixels.

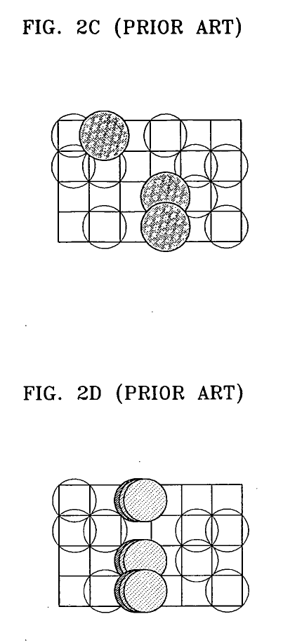

FIG. 3 is a block diagram of an apparatus for compensating for a defective pixel according to an embodiment of the present invention. The apparatus comprises: a defective image-forming element determining unit 300, a defective pixel information detecting unit 310, and a halftoning unit 320. Here, the halftoning unit 320 comprises an adder 330, a quantizing unit 340, a data selecting unit 350, a subtracter 360, and an error diffusing unit 370.

The defective image-forming element determining unit 300 determines a defective image-forming element among image-forming elements. Here, the defective image-forming element may be an ink emission nozzle that emits ink more or less than a predetermined amount among the ink emission nozzles of an inkjet printer, or a position of a photosensitive drum that is charged more or less than a predetermined quantity of electric charges among the positions of the photosensitive drum of a laser printer. Here, the predetermined amount or quantity means an input of the image-forming element, e.g., an ink emission amount that corresponds to halftone-processed data. A printer has halftone-processed data, that is, 0 or 1 for a quantized gray scale data value, and emits or does not emit a predetermined amount of ink depending on that data value. Also, in the laser printer, the respective positions of the photosensitive drum should be charged with a quantity of electric charges required for an ink toner to be attached to the photosensitive drum. In this case, the predetermined quantity indicates a quantity of electric charges appropriate for the ink toner to be attached to the photosensitive drum. Also, a defective image-forming element in a display device may be generated in the case where an LED used for the display device is damaged, and so brightness of a predetermined level cannot be displayed.

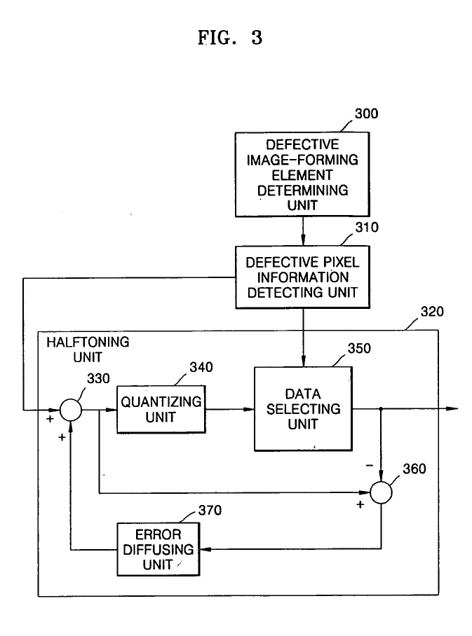

FIG. 4A is a conceptual view illustrating a case where a defective ink emission nozzle exists in a shuttle-type ink emission nozzle set.

FIG. 4B is a conceptual view illustrating a case where a defective ink emission nozzle exists in an array-type ink emission nozzle set.

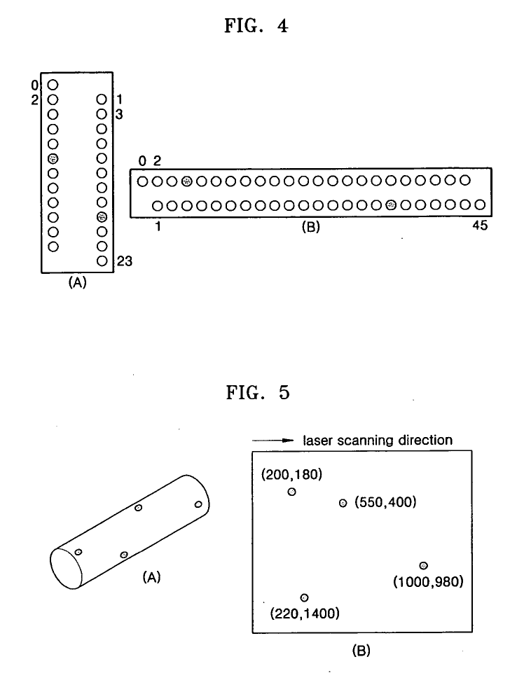

FIGS. 5A and 5B are conceptual views illustrating a case where defective portions exist on a photosensitive drum surface of a laser printer. FIG. 5A illustrates a photosensitive drum having portions where a charged quantity is insufficient, and FIG. 5B illustrates the photosensitive drum represented as a plane with coordinates.

The defective image-forming element determining unit 300 stores values 10 and 17, and values 6 and 33 for the cases of FIGS. 4A and 4B, respectively. In the case of the photosensitive drum of FIG. 5, the defective image-forming element determining unit 300 stores coordinate values of (200, 180), (550, 400), (1000,980), and (220, 1400), which are insufficiently charged positions. These values are provided as defective image-forming element information to the defective pixel information detecting unit 310.

A method of determining a defective image-forming element can be a method of incorporating a module for detecting whether an ink emission nozzle normally operates in an image-forming apparatus, or a method of using a separate device for detecting the position of a defective image-forming element from an output of the image-forming apparatus.

The defective pixel information detecting unit 310 detects whether input continuous gray scale data forms a defective pixel caused by a defective image-forming element and outputs the detected result as defective pixel information. It is possible to detect the defective pixel by mapping in advance the pixels to be formed by the respective image-forming elements using the defective image-forming element information provided from the defective image-forming element determining unit 300. That is, a coordinate (Xd, Yd) of a pixel that corresponds to the defective ink emission nozzle is calculated using the defective image-forming element information, and the calculated position is compared with a coordinate (m,n) of a currently halftone-processed pixel, and if the two positions are identical, the data selecting part 350 selects a preset signal.

The defective pixel information comprises information regarding a defective pixel, and an example of the defective pixel information will be described below together with the data selecting part 350.

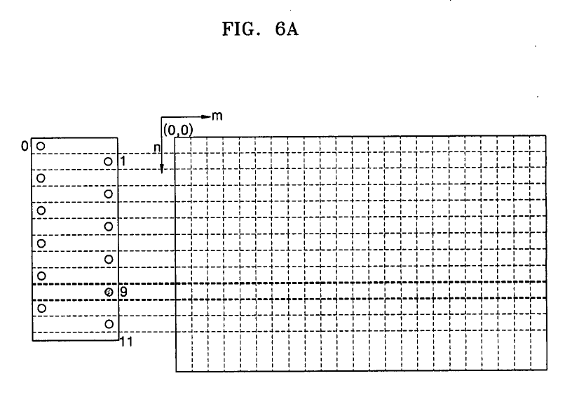

FIG. 6A is a conceptual view illustrating an example of detecting a defective pixel when a shuttle-type ink emission nozzle set is used.

FIG. 6B is a conceptual view illustrating an example of detecting a defective pixel when an array-type ink emission nozzle set is used.

Since a 9^{th} ink emission nozzle is defective in a shuttle-type printer head, as shown in FIG. 6A, all rows where n=9 among coordinates (m,n) are detected as defective pixels. Also, since a 7^{th} ink emission nozzle is defective in an array-type printer head, as shown in FIG. 6B, all columns where m=7 are detected as defective pixels. The defective pixel information detecting unit 310 and the data selecting part 350 operate so that a preset signal is output for all of the pixels that correspond to the 9^{th} row or the 7^{th} column, respectively, for the arrangement in FIGS. 6A and 6B by way of an example.

The adder 330 adds input continuous gray scale data x(m,n) and an error e′(m,n) diffused to the coordinate (m,n) to provide the added result data u(m,n) to the quantizing unit 340. The diffused error e′(m,n) will be described below.

The quantizing unit 340 quantizes the added data u(m,n) into a predetermined level and provides the quantized data to the data selecting unit 350. The quantized data may have a binary data form of 0 or 1 but may have a data form having a quantized level greater than the binary data depending on an image-forming element. For example, in the case where there are three ink emission nozzles that correspond to one pixel and ink amounts emitted from the respective ink emission nozzles are different, four gray scales comprising a blank pixel may be generated. In that case, the quantized data value can be 2 bits.

The data selecting unit part 350 selects preset data or the quantized data on the basis of the defective pixel information and outputs the selected result as halftone-processed data.

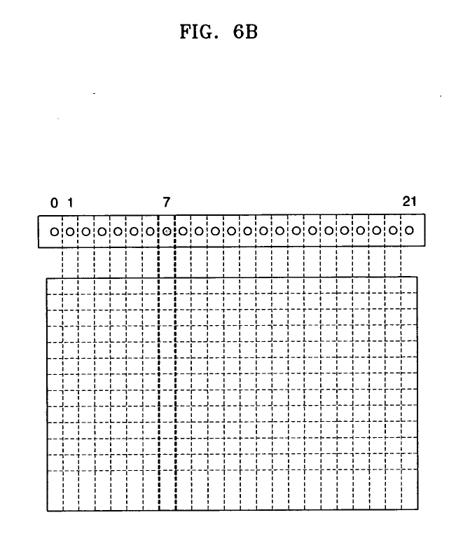

FIGS. 7A and 7B are block diagrams illustrating operations of the defective pixel information detecting unit 310 and the data selecting unit 350 according to exemplary embodiments of the present invention.

According to the current exemplary embodiments of the present invention, defective pixel information is represented by a selection control signal of a multiplexer.

FIG. 7A is a block diagram for illustrating when an image-forming apparatus supports halftone-processed data having two values. When the defective image-forming element is an ink emission nozzle through which ink is not emitted in an inkjet printer, a preset value y0 is a halftone-processed data value that determines that the ink is not emitted. For example, in the case of an image-forming apparatus that does not emit the ink when the halftone-processed data is 0, the value y0 is set to 0. When detecting information that a current coordinate is to form a defective pixel, the defective pixel information detecting unit 310 provides a selection control signal to the data selecting unit 350 so that the data selection part 350 may select the value y0.

FIG. 7B is a block diagram for illustrating when an image-forming apparatus supports halftone-processed data having four values according to an embodiment of the present invention.

With reference to FIG. 7B, three ink emission nozzles emitting different ink emission amounts, respectively, for one pixel, is used as an example. In this case, the number of reproduced gray scales becomes four, including a gray scale for a blank pixel. When one of the three ink emission nozzles is defective and a current pixel corresponds to the defective ink emission nozzle, there are two methods of compensating for a defective pixel. That is, there is a first method of generating a selection control signal that allows data making the ink not to be emitted to be selected. Also, there is a second method of generating a selection control signal that allows halftone-processed data generating a gray scale most similar to the gray scale to be formed on the defective pixel to be selected. The first method has an effect where an actual error is accurately reflected in halftoning by selecting data generating the gray scale formed by the defective image-forming element.

Y0 is a data signal that corresponds to a blank pixel and Y1, Y2, and Y3 are data signals that allow the ink to be emitted. In this case, Y1, Y2, and Y3 are aligned in an order that an ink emission amount increases. In particular, when a gray scale to be formed by a current coordinate is a gray scale Y3 and the ink emission nozzle that corresponds to the gray scale Y3 is defective, Y0 is selected using the first method and Y2 is selected using the second method. To generate a selection control signal that allows a Y0 signal or a Y2 signal to be selected, the defective pixel information detecting unit 310 should have information that a gray scale to be formed by a current coordinate is a gray scale Y3. The above information can be obtained by the defective pixel information detecting unit 310 having a unit that performs halftoning. As another method of obtaining the above information, unlike the structure of FIG. 3, a method of receiving an output u(m,n) of the quantizing unit 340 and determining a gray scale to be formed by a current coordinate is provided.

With reference to FIG. 3, the subtracter 360 subtracts halftone-processed data b(m,n) from input data u(m,n) of the quantizing unit 340 and outputs the subtracted result e(m,n) as an error.

The error diffusing unit 370 diffuses an error provided from the subtracter 370 to neighboring pixels. For example, an error e′(m,n) diffused to a current pixel x(m,n) is obtained by Equation 1.
e′(m,n)=Σ_{(k,l)εR}e(m−k,n−l)w(k,l) (1)
where w(k,l) is a weight diffusing an error to neighboring pixels.

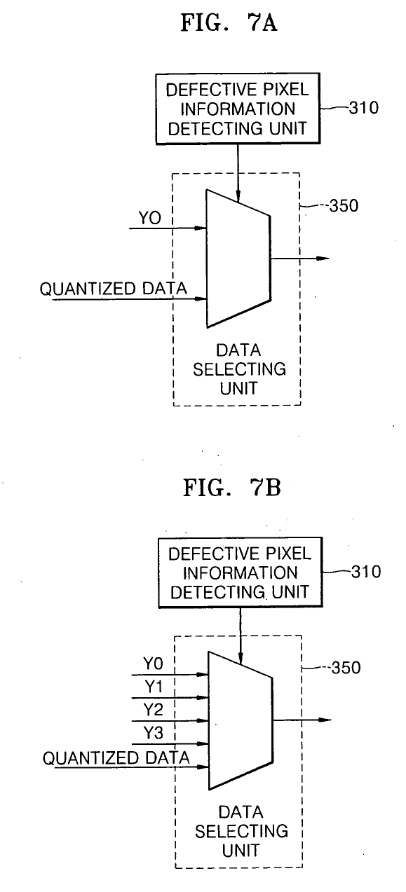

FIG. 8 illustrates an example of a Floyd-Steinberg error filter according to an exemplary embodiment of the present invention. A mark * indicates a coordinate of a current pixel and neighboring numeric values are weights representing an amount in which an error of the current pixel is to be diffused to the neighboring pixels.

As a result, data u(m,n) obtained by error-diffusing currently input continuous gray scale data is obtained by Equation 2.

$$u ( m , n ) = x ( m , n ) + {\sum }_{( k , l ) ∈ R} e ( m - k , n - l ) w ( k , l ) \qquad ( 2 )$$

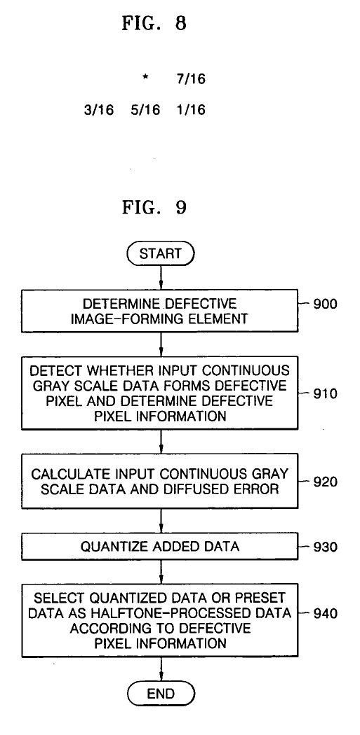

FIG. 9 is a flowchart for explaining operations of an apparatus and a method for compensating for a defective pixel according to an exemplary embodiment of the present invention.

First, a defective image-forming element is determined by the defective image-forming element determining unit 300 (operation 900). The method of determining the defective image-forming element has been described previously.

Whether input continuous gray scale data forms a defective pixel caused by a defective image-forming element is detected by the defective pixel information detecting unit 310 and the detected result is determined as defective pixel information (operation 910).

The continuous gray scale data and a diffused error provided from the error diffusing unit 370 are added by the adder 330, and the summed output is provided to the quantizing unit 340 (operation 920).

The added data is quantized by the quantizing unit 340 (operation 930).

Whether the continuous gray scale data forms the defective pixel is judged on the basis of the defective pixel information. If the defective pixel is determined to be formed, the preset data is determined as the halftone-processed data. If the defective pixel is determined not to be formed, the quantized data is determined as the halftone-processed data (operation 940). The defective pixel information is provided by the defective pixel information detecting unit 310 and the determining of the halftone-processed data is performed by the data selecting unit 350.

The error is calculated by the subtracter 360 subtracting the added data from the halftone-processed data, and the calculated error is diffused to the neighboring pixels by the error diffusing unit 370 and input to the adder 330.

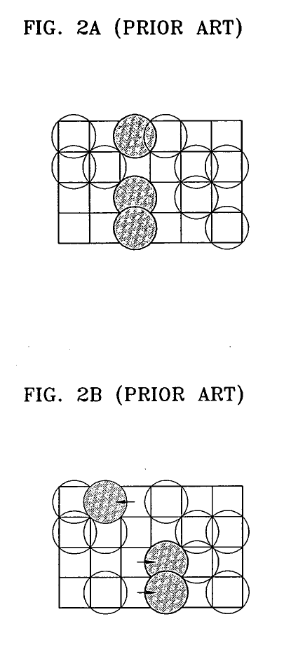

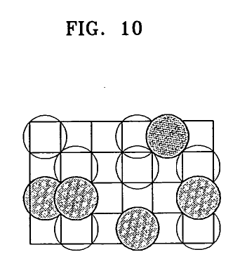

FIG. 10 is a view illustrating a printed result obtained using an exemplary embodiment of the present invention and shall be compared with the conventional data rearranging technique of FIG. 2A.

As in FIGS. 2B and 2C, gray circles are pixels used for compensating for the defective pixels. Unlike FIGS. 2B and 2C, however, the pixels output for compensation in FIG. 10 are not necessarily adjacent to the defective pixels. That is, according to an exemplary embodiment of the present invention, even in a case where the quantizing unit 340 determines the ink to be emitted, the data selecting unit 350 controls the ink not to be emitted for the defective pixels. Therefore, a quantized error diffused to the neighboring pixels increases and the increased error increases a probability that the ink can be emitted to the neighboring pixels of the defective pixel. That is, unlike FIGS. 2B and 2C, more halftone-processed data is rearranged.

The invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network coupled computer systems so that the computer-readable code is stored and executed in a distributed fashion. Also, functional programs, codes, and code segments for accomplishing the present invention can be easily construed by programmers skilled in the art to which the present invention pertains.

According to the present invention, in an image-forming apparatus (such as a printer, an LED, etc.) reproducing continuous gray scales using a plurality of image-forming elements limited gray scale forming pixels, image quality deterioration caused by defective pixels can be compensated for by performing halftoning in consideration of the defective image-forming element when some of the image-forming elements are defective.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for compensating for a defective pixel comprising:
a defective pixel information detecting unit for detecting whether input continuous gray scale data forms a defective pixel caused by a defective image-forming element and outputting the detected result as defective pixel information; and
a halftoning unit halftoning the continuous gray scale data using error diffusion, depending on the defective pixel information.

2. The apparatus of claim 1, further comprising a defective image-forming element determining unit detecting the defective image-forming element among image-forming elements.

3. The apparatus of claim 1, wherein the defective image-forming element is an ink emission nozzle emitting ink more or less than a predetermined amount the among ink emission nozzles of an inkjet printer.

4. The apparatus of claim 1, wherein the defective image-forming element is a position of a photosensitive drum of a laser printer that is charged more or less than a predetermined quantity of electric charges among positions on the photosensitive drum of the laser printer.

5. The apparatus of claim 1, wherein the halftoning unit comprises:
a quantizing unit quantizing input data;
a data selecting unit selecting preset data or the quantized data based on the defective pixel information and outputting the selected data as halftone-processed data;
a subtracter subtracting an output of the data selecting unit from the input data and outputting the subtracted result as an error;
an error diffusion unit diffusing the error to neighboring pixels; and
an adder adding the continuous gray scale data and the diffused error and outputting the result as the input data.

6. The apparatus of claim 5, wherein the preset data is data that generates a gray scale similar to a gray scale of the quantized data among data driving one or more normal image-forming elements that correspond to a position of the defective pixel.

7. The apparatus of claim 5, wherein the preset data is data that corresponds to a gray scale formed by the defective image-forming element.

8. The apparatus of claim 5, wherein the preset data is data that corresponds to a blank pixel.

9. A method of compensating for a defective pixel comprising:
detecting whether input continuous gray scale data forms a defective pixel caused by a defective image-forming element and determining the detected result as defective pixel information; and
halftoning the continuous gray scale data using error diffusion, depending on the defective pixel information.

10. The method of claim 9, further comprising detecting the defective image-forming element among a plurality of image-forming elements.

11. The method of claim 9, wherein the defective image-forming element is an ink emission nozzle emitting ink more or less than a predetermined amount among ink emission nozzles of an inkjet printer.

12. The method of claim 9, wherein the defective image-forming element is a position of a photosensitive drum of a laser printer that is charged more or less than a predetermined quantity of electric charges among positions on the photosensitive drum of the laser printer.

13. The method of claim 9, wherein the halftoning comprises:
adding the continuous gray scale data and a diffused error to generate input data;
quantizing the input data;
determining whether the continuous gray scale data forms a defective pixel based on the defective pixel information;
determining preset data as halftone-processed data if the defective pixel is determined to be formed; and
determining the quantized data as the halftone-processed data if the defective pixel is determined not to be formed,
wherein an error is calculated by subtracting the halftone-processed data from the input data, and the diffused error is generated by diffusing the calculated error to neighboring pixels.

14. The method of claim 13, wherein the preset data is data that generates a gray scale similar to a gray scale of the quantized data among data driving one or more normal image-forming elements that correspond to a position of the defective pixel.

15. The apparatus of claim 13, wherein the preset data is data that corresponds to a gray scale formed by the defective image-forming element.

16. The apparatus of claim 13, wherein the preset data is data that corresponds to a blank pixel.

17. A computer-readable recording medium having recorded thereon a program for compensating for a defective pixel, wherein the program controls an apparatus for compensating for the defective pixel and comprises:
a first set of instructions for detecting whether input continuous gray scale data forms a defective pixel caused by a defective image-forming element and determining the detected result as defective pixel information; and
a second set of instructions for halftoning the continuous gray scale data using error diffusion depending on the defective pixel information.

18. The computer-readable recording medium of claim 17, wherein the second set of instructions comprises:
a third set of instructions for adding the continuous gray scale data and a diffused error to generate input data;
a fourth set of instructions for quantizing the input data;
a fifth set of instructions for determining whether the continuous gray scale data forms a defective pixel based on the defective pixel information;
a sixth set of instructions for determining preset data as halftone-processed data if the defective pixel is determined to be formed; and
a seventh set of instructions for determining the quantized data as the halftone-processed data if the defective pixel is determined not to be formed,
wherein an error is calculated by subtracting the halftone-processed data from the input data, and the diffused error is generated by diffusing the calculated error to neighboring pixels.
